(19) United States
(12) Patent Application Publication
(10) Pub. No.: US 2012/0008911 A1
(43) Pub. Date: Jan. 12, 2012

(54) REPRODUCTION APPARATUS, DISPLAY APPARATUS, AV NETWORK SYSTEM, REPRODUCTION METHOD, PROGRAM, AND INTEGRATED CIRCUIT

(76) Inventor: Junji Yoshida, Osaka (JP)

(21) Appl. No.: 13/257,641

(22) PCT Filed: Nov. 10, 2010
(86) PCT No.: PCT/JP2010/006580

§ 371 Date: Sep. 20, 2011

(30) Foreign Application Priority Data
Dec. 9, 2009 (JP) 2009-279152

(51) Int. Cl. H04N 5/775

(52) U.S. Cl. 386/230; 386/E05.07

(57) ABSTRACT

A BD player (13) that is a reproduction apparatus includes: a control command processing unit (13b) that is a selecting unit which obtains a priority indicating a priority order of each of a TV (11) and a projector (12) that are a plurality of display apparatuses, to display content, from a corresponding one of the TV (11) and the projector (12) via a communication network, and selects a display apparatus which holds a highest priority from among the TV (11) and the projector (12); and a content transmitting unit (13c) which transmits the content to the display apparatus selected by the control command processing unit (13b).

### TECHNICAL FIELD

The present invention relates to reproduction apparatuses, and particularly to a reproduction apparatus which transmits content to one of a plurality of display apparatuses connected thereto via a communication network.

### BACKGROUND ART

In recent years, audio and visual (AV) devices have improved in image quality and sound quality, and Blu-ray disc (BD) players and set top boxes (STBs) are now used so widely that people are able to enjoy what is called a high definition (HD) video even at home.

In addition, along with the spread of the network, the high-definition multimedia interface (HDMI), and the like, what is called a link function has become prevalent which provides various additional functions by mutually coordinated operations of a plurality of AV devices.

As an example of the link function, upon the start of reproducing content by a BD player, a television and an AV amplifier are automatically powered on, and the inputs of the television and the AV amplifier are switched to the BD player side. As such, there is a function with which the content reproduced by the BD player can be readily viewed without the need to operate the television and the AV amplifier. Such a function is generally called “one-touch play”.

In order to implement the link function such as this one-touch play, the HDMI standard disclosed by the Non Patent Literature 1 specifies a device control protocol called a consumer electronics control (CEC).

Here, with reference to FIGS. 10 and 11, an example of operation of the one-touch play in a conventional AV network system connected with HDMI is described. FIG. 10 shows an example of a structure of a conventional typical AV network system. FIG. 11 shows an example of a CEC command sequence at the start of reproduction by a BD player in the conventional typical AV network system.

In FIG. 10, a TV 91 has two HDMI inputs (an HDMI input 1 and an HDMI input 2), the HDMI input 1 of the TV 91 and a BD player 92 are connected with an HDMI cable 94, and the HDMI input 2 of the TV 91 and an STB 93 are connected with an HDMI cable 95.

To change the reproduction apparatus (that is the BD player 92 and the STB 93 in this case), a user used to usually need to manually switch the input of the TV 91. However, when each device supports the CEC, the use of CEC commands allows automatic switching of the input.

For example, upon the start of content reproduction by the BD player 92, the BD player 92 first transmits a command <Text View On> to the TV 91 as shown in FIG. 11. Upon the receipt of the command <Text View On> from the BD player 92, the TV 91 of which power state is an OFF state switches ON.

Next, the BD player 92 transmits a command <Active Source> to all the devices connected thereto with the HDMI. Upon the receipt of the command <Active Source>, the TV 91 switches to the HDMI input 1 to which the BD player 92 that is the source of the command <Active Source> is connected. The above operation allows the content reproduced by the BD player 29 to be viewed on the TV 91 without the need of a user to manually switch the input of the TV 91.

To view the content provided by the STB 93, the STB 93 performs the same or like operation as the BD player 92 in FIG. 11, which allows the content provided by the STB 93 to be viewed on the TV 91 without the need of a user to manually switch the input of the TV 91.

In the manner as above, the use of CEC commands that are a device control protocol enables implementation of the one-touch play.

Patent Literature 1 discloses a technique of implementing the one-touch play in a network in which the TV and the BD player are connected with wireless communication interfaces instead of wired communication interfaces such as the HDMI.

Next, with reference to FIGS. 12 to 15, an operation of the one-touch play in the AV network system connected with the wireless communication interfaces is described. FIG. 12 shows a structure of a conventional typical AV network system using wireless communication interfaces. FIG. 13 shows an example of an operation sequence at the start of reproduction by the BD player in the conventional typical AV network system using wireless communication interfaces. FIG. 14 shows a structure of a conventional AV network system in which two display apparatuses using wireless communication interfaces are present. FIG. 15 shows an example of an operation sequence at the start of reproduction by a BD player when viewing content on a projector, in the conventional AV network system in which two display apparatuses using wireless communication interfaces are present.

In FIG. 12, a TV 111 has a wireless input unit C and is capable of performing communication by establishing a connection to a wireless output unit A of a BD layer 112 or a wireless output unit B of an STB 113.

Next, with reference to FIG. 13, the one-touch play operation at the start of content reproduction by the BD player 112 is described.

In FIG. 13, upon a start of content reproduction by the BD player 112, the BD player 112 first transmits a power-on request command to the TV 111 through a low-rate physical layer (LRP).

Upon receipt of the power-on request command from the BD player 112 through the LRP, the TV 111 of which power state is an ON state maintains the ON state while the TV 111 of which power state is an OFF state switches ON.

Next, the BD player 112 executes, for the TV 111, a connection establishment process of a high-rate physical layer (HRP). The connection establishment process generally includes a determination of a transmission device (that is the BD player 112 in this case) and a receiving device (that is the TV 111 in this case) between which video, sound, and data are conveyed, and an acquisition of a radio band.

According to the establishment of HRP connection between the TV 111 and the BD player 112, the TV 111 switches from the wireless input unit C to the wireless output unit A (on the BD player 112). This allows a user to view, on the TV 111, the content reproduced by the BD player 112, without the need of manually switching the input of the TV 111.

To stop viewing, on the TV 111, the content reproduced by the BD player 112, either the TV 111 or the BD player 112 executes an HRP disconnection process. This disconnection process includes a release of the radio band.

On the other hand, to view the content provided by the STB 113, the STB 113 performs the same or like operation as the BD player 112 shown in FIG. 13, which allows the content provided by the STB 113 to be viewed on the TV 111 without the need of a user to manually switch the input of the TV 111.

In the manner as above, the one-touch play can be implemented in the AV devices connected with the wireless communication interfaces.

With some wireless communication interfaces, a plurality of display apparatuses (that are the TV 111 and a projector 114 in this case) can be concurrently present in a network as shown in FIG. 14.

In such a case, the BD player 112 is not only capable of one-touch play for the TV 111 based on the operation sequence shown in FIG. 13, but also capable of one-touch play for the projector 114 based on the operation sequence shown in FIG. 15.

The operation of the projector 114 in FIG. 15 is the same or alike as the operation of the TV 111 in FIG. 13 and therefore not described here.

### CITATION LIST

### Patent Literature

[PTL 1] Japanese Unexamined Patent Application Publication NO. 2008-252929

### Non Patent Literature

[NPL 1] HDMI standard (High-Definition Multimedia Interface Specification Version 1.3a)

### SUMMARY OF INVENTION

### Technical Problem

However, in the AV network system where a plurality of display apparatuses are present as shown in FIG. 14, there is a problem of not knowing, for example, in content reproduction started by the BD player 112, whether or not the one-touch play is possible for the display apparatus which the BD player 112 intends. For example, in the case where the BD player 112 always performs the one-touch play for the TV 111, there is no problem when a user wishes to view content on the TV 111, but, even when a user wishes to view content on the projector 114, the TV 111 is automatically powered on, with the result that the content transmitted from the BD player 112 will be displayed not on the projector 114 but on the TV 111.

The present invention has been devised in view of such a problem, and an object of the present invention is to provide a reproduction apparatus capable of causing a user's intended display apparatus to automatically display content reproduced by the reproduction apparatus, in an AV network system where the reproduction apparatus and a plurality of display apparatuses are present.

### Solution to Problem

A reproduction apparatus according to an aspect of the present invention transmits content to one of a plurality of display apparatuses each of which is connected to the reproduction apparatus via a communication network. Specifically, the reproduction apparatus includes: a selecting unit configured to obtain a priority from each of the display apparatuses via the communication network and select one of the display apparatuses which holds a highest priority, the priority indicating a priority order of a corresponding one of the display apparatuses to display the content; and a content transmitting unit configured to transmit the content to the display apparatus selected by the selecting unit.

Transmitting content to a selected display apparatus with a high priority as in the above structure allows the content reproduced by the reproduction apparatus, to be automatically displayed on a user's intended display apparatus.

As an example, each of the display apparatuses may hold a plurality of priorities in association with a plurality of possible operating states of the display apparatus. In this case, the selecting unit may obtain only one of the priorities which is associated with a current operating state of each of the display apparatuses.

Furthermore, with a timing of when a change in the operating state of the selected display apparatus is detected, the selecting unit may obtain again the priority associated with the current operating state of each of the display apparatuses and newly select one of the display apparatuses which holds a highest priority.

Furthermore, the selecting unit may newly select one of the display apparatuses which holds a highest priority and is different from the display apparatus selected until immediately before.

Furthermore, the selecting unit may transmit, to the selected display apparatus, a power-on request command for placing the display apparatus in power-on state, and execute a process of establishing a connection between the reproduction apparatus and the display apparatus. In addition, the content transmitting unit may transmit the content through the established connection.

Furthermore, the selecting unit may transmit, to the selected display apparatus, a power-state check command for checking a current power state, and transmit the power-on request command to the selected display apparatus when a power-state notify command received in response to the power-state check command has a value indicating that the current power state of the display apparatus is OFF.

Furthermore, the selecting unit may (i) transmit, to the selected display apparatus, a power-state check command for checking a current power state, and after checking that a power-state notify command received in response to the power-state check command has a value indicating that the current power state of the display apparatus is ON, (ii) start the process of establishing the connection.

Furthermore, the selecting unit may execute a process of selecting one of the display apparatuses which holds a highest priority, with one of the following timings: a timing of when the reproduction apparatus is powered on; a timing of when a user is allowed to select the content reproduced by the reproduction apparatus; and a timing of when reproduction of the content by the reproduction apparatus starts.

As an example, the communication network may be of a wireless high definition (wirelessHD). The selecting unit may obtain the priority through a low-rate physical layer (LRP), and the content transmitting unit may transmit the content through a high-rate physical layer (HRP).

As another example, each of the display apparatuses may hold a plurality of priorities in association with a plurality of possible operating states of the display apparatus. In addition, the selecting unit may obtain, from each of the display apparatuses, the priorities held by the display apparatus, and a current operating state of the display apparatus, and select one of the display apparatuses of which priority associated with the current operating state is highest.

A display apparatus according to an aspect of the present invention is a display apparatus that is one of a plurality of display apparatuses connected to a reproduction apparatus via a communication network and displays content received from the reproduction apparatus. Specifically, the display apparatus includes: a priority holding unit configured to hold a priority indicating a priority order of the display apparatus among the plurality of display apparatuses to display the content received from the reproduction apparatus; a notifying unit configured to notify, via the communication network, the reproduction apparatus of the priority held by the priority holding unit, in response to a request from the reproduction apparatus; and a display unit configured to display the content received from the reproduction apparatus.

Furthermore, the priority holding unit may hold a plurality of priorities associated with a plurality of power states of the display apparatus. In addition, a priority associated with an ON state may be higher than a priority associated with an OFF state.

An AV network system according to an aspect of the present invention includes: a reproduction apparatus; and a plurality of display apparatuses each of which is connected to the reproduction apparatus via a communication network, and displays, on one of the display apparatuses, content transmitted from the reproduction apparatus via the communication network. The reproduction apparatus includes: a selecting unit configured to obtain a priority from each of the display apparatuses via the communication network and select one of the display apparatuses which holds a highest priority, the priority indicating a priority order of a corresponding one of the display apparatuses to display the content; and a content transmitting unit configured to transmit the content to the display apparatus selected by the selecting unit. Each of the display apparatuses includes: a priority holding unit configured to hold a priority indicating a priority order of the display apparatus among the plurality of display apparatuses to display the content received from the reproduction apparatus; a notifying unit configured to notify, via the communication network, the reproduction apparatus of the priority held by the priority holding unit, in response to a request from the reproduction apparatus; and a display unit configured to display the content received from the reproduction apparatus.

A reproduction method according to an aspect of the present invention is a method of transmitting content to one of a plurality of display apparatuses each of which is connected via a communication network. Specifically, the reproduction method includes: obtaining a priority from each of the display apparatuses via the communication network and selecting one of the display apparatuses which holds a highest priority, the priority indicating a priority order of a corresponding one of the display apparatuses to display the content; and transmitting the content to the display apparatus selected in the selecting.

A program according to an aspect of the present invention causes a computer to transmit content to one of a plurality of display apparatuses each of which is connected via a communication network. Specifically, the program causes the computer to execute: obtaining a priority from each of the display apparatuses via the communication network and selecting one of the display apparatuses which holds a highest priority, the priority indicating a priority order of a corresponding one of the display apparatuses to display the content; and transmitting the content to the display apparatus selected in the selecting.

An integrated circuit according to an aspect of the present invention transmits content to one of a plurality of display apparatuses each of which is connected via a communication network. Specifically, the integrated circuit includes: a selecting unit configured to obtain a priority from each of the display apparatuses via the communication network and select one of the display apparatuses which holds a highest priority, the priority indicating a priority order of a corresponding one of the display apparatuses to display the content; and a content transmitting unit configured to transmit the content to the display apparatus selected by the selecting unit.

### Advantageous Effects of Invention

According to the present invention, transmitting content to a selected display apparatus with a high priority allows the content reproduced by the reproduction apparatus, to be displayed on a user's intended display apparatus.

### BRIEF DESCRIPTION OF DRAWINGS

FIG. 1 is a functional block diagram of display apparatuses and a reproduction apparatus according to the first embodiment of the present invention.

FIG. 2 shows an example of a structure of an AV network system including the display apparatuses and the reproduction apparatus according to the first embodiment of the present invention.

FIG. 3 shows a sequence of a one-touch play operation started from a BD player which is the reproduction apparatus according to the first embodiment of the present invention, when a projector which is one of the display apparatuses according to the first embodiment of the present invention is in power-on state.

FIG. 4 shows a sequence of a one-touch play operation started from the BD player which is the reproduction apparatus according to the first embodiment of the present invention, when the projector which is one of the display apparatuses according to the first embodiment of the present invention is in power-off state.

FIG. 5 shows an operation sequence in the case where the projector included in the AV network system according to the first embodiment of the present invention is powered off while content is being viewed on the projector.

FIG. 6 shows an example of a structure of an AV network system including display apparatuses and a reproduction apparatus according to the second embodiment of the present invention.

FIG. 7 shows a sequence of a one-touch play operation started from a BD player which is the reproduction apparatus according to the second embodiment of the present invention, when a projector which is one of the display apparatuses according to the second embodiment of the present invention is in power-on state.

FIG. 8 shows a sequence of a one-touch play operation started from the BD player which is the reproduction apparatus according to the second embodiment of the present invention, when the projector which is one of the display apparatuses according to the second embodiment of the present invention is in power-off state.

FIG. 9 shows an operation sequence in the case where the projector included in the AV network system according to the second embodiment of the present invention is powered off while content is being viewed on the projector.

FIG. 10 shows an example of a structure of a conventional typical AV network system.

FIG. 11 shows an example of a CEC command sequence at the start of reproduction by a BD player in the conventional typical AV network system.

FIG. 12 shows a structure of a conventional typical AV network system using wireless communication interfaces.

FIG. 13 shows an example of an operation sequence at the start of reproduction by a BD player in the conventional typical AV network system using wireless communication interfaces.

FIG. 14 shows a structure of a conventional AV network system in which two display apparatuses using wireless communication interfaces are present.

FIG. 15 shows an example of an operation sequence at the start of reproduction by a BD player when viewing content on a projector, in the conventional AV network system in which two display apparatuses using wireless communication interfaces are present.

### DESCRIPTION OF EMBODIMENTS

Embodiments for implementing the present invention are described below with reference to the drawings.

### First Embodiment

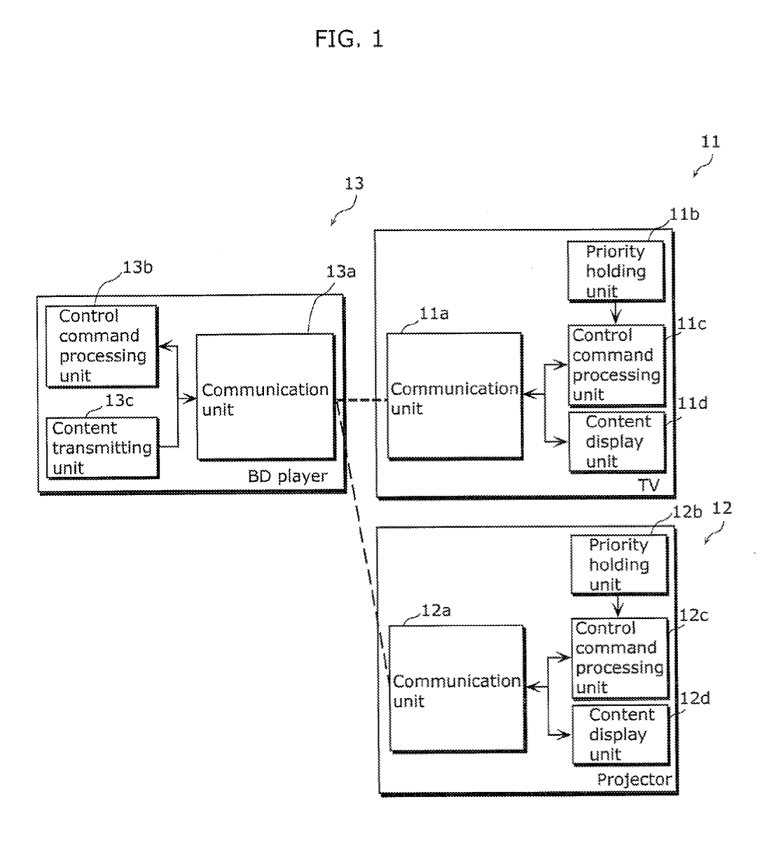

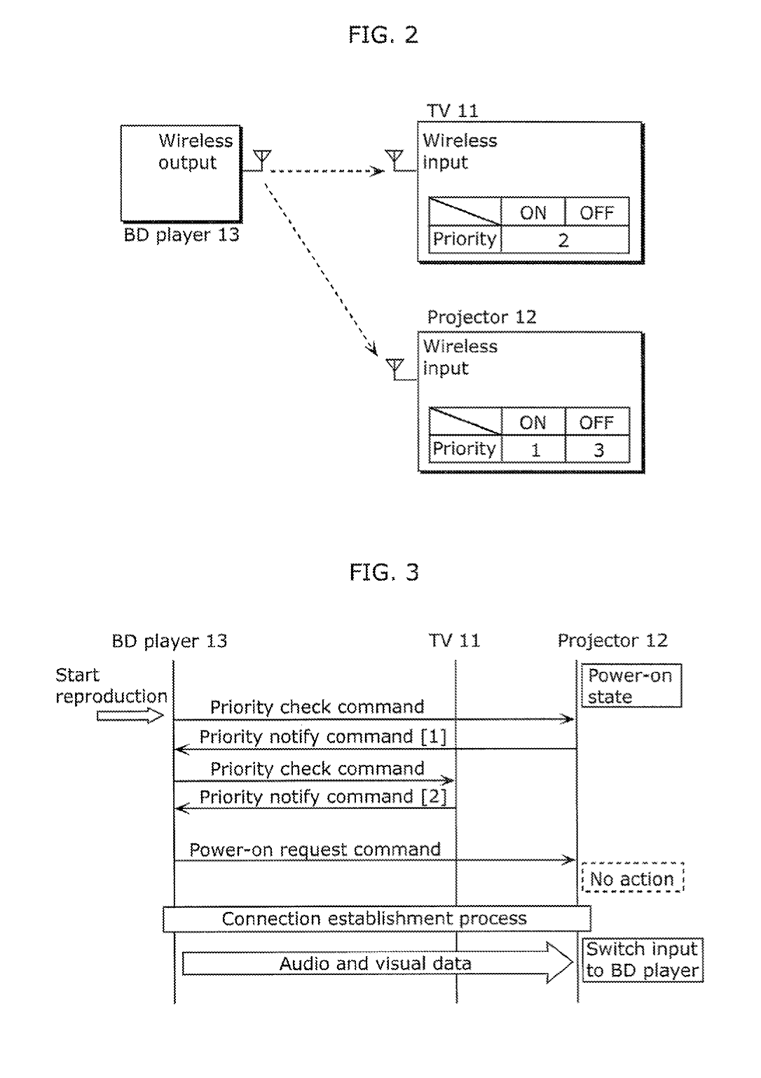

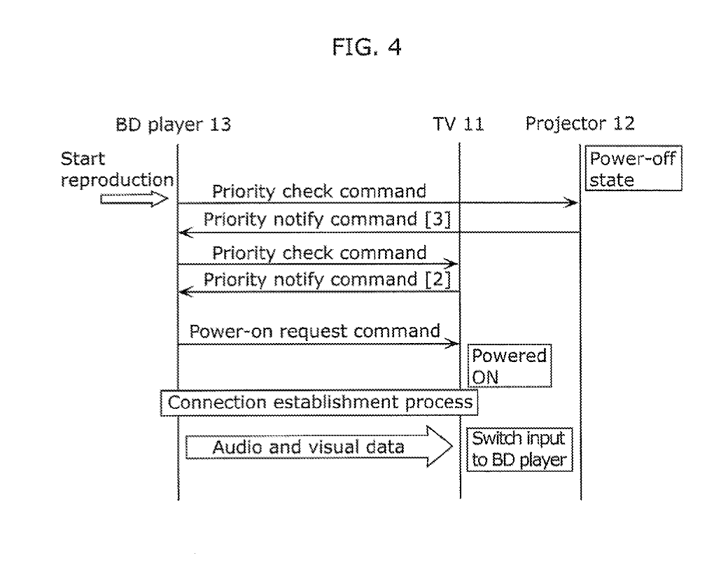

With reference to FIGS. 1 to 4, a structure of an AV network system and a one-touch play operation according to the first embodiment of the present invention are described. FIG. 1 is a functional block diagram of display apparatuses and a reproduction apparatus according to the first embodiment of the present invention. FIG. 2 shows an example of the structure of the AV network system according to the first embodiment of the present invention. FIG. 3 shows a sequence of a one-touch play operation started from a BD player which is the reproduction apparatus according to the first embodiment of the present invention, when a projector which is one of the display apparatuses according to the first embodiment of the present invention is in power-on state. FIG. 4 shows a sequence of a one-touch play operation started from the BD player which is the reproduction apparatus according to the first embodiment of the present invention, when the projector which is one of the display apparatuses according to the first embodiment of the present invention is in power-off state.

In FIGS. 1 and 2, the AV network system according to the first embodiment of the present invention includes a BD player 13 that is the reproduction apparatus, and a TV 11 and a projector 12 that are the display apparatuses each connected to the BD player 13 via a wireless communication network. Thus, the AV network system according to the first embodiment of the present invention includes one reproduction apparatus and a plurality of display apparatuses.

The TV 11 and the projector 12 that are the display apparatuses receive visual data or audio and visual data from the BD player 13 that is the reproduction apparatus, and are also capable of transmitting control commands to and receiving control commands from the BD player 13, via wireless communication networks. In addition, with an established connection to the BD player 13, each of the TV 11 and the projector 12 is capable of displaying the received visual data or audio and visual data. Furthermore, among information on display priorities (hereinafter referred to as priorities) assigned to all the display apparatuses connected to the BD player 13 via wireless communication networks, information on the priority of the TV 11 or the projector 12 is held by the TV 11 or the projector 12 itself.

Specifically, the TV 11 includes a communication unit 11a, a priority holding unit 11b, a control command processing unit 11c and a content display unit 11d, as shown in FIG. 1. Likewise, the projector 12 includes a communication unit 12a, a priority holding unit 12b, a control command processing unit 12c, and a content display unit 12d. Since the constituents of the projector 12 operate in the same way as those of the TV 11, only the constituents of the TV 11 are described below.

The communication unit 11a is a communication interface which performs a wireless communication in a scheme which complies with the HDMI standard. Specifically, the wireless communication is performed selectively using the high rate PHY (HRP) and the low rate PHY (LRP) as appropriate. The HRP has a bandwidth of 4.0 G (bps) and enables a one-way wireless transmission (from the BD player 13 toward the TV 11). On the other hand, the LRP has a bandwidth of 40 M (bps) and enables a two-way wireless transmission.

In the first embodiment, audio and visual data (content data) is wirelessly transmitted from the BD player 13 to the TV 11 (or the projector 12) using the HRP. Meanwhile, the BD player 13 and the TV 11 (or the projector 12) wirelessly transmit control commands, such as a consumer electronics control message, to each other using the LRP.

The priority holding unit 11b holds a priority indicating a priority order of the TV 11 to display content among a plurality of display apparatuses (i.e. the TV 11 and the projector 112) connected to the AV network. In other words, among the priority orders assigned to the plurality of display apparatuses (which are the TV 11 and the projector 12 in this embodiment) connected to the AV network system, the information (priority) indicating a priority order assigned to a corresponding display apparatus (i.e. the TV 11) is held.

It is to be noted that the priority holding unit 11b may hold a plurality of priorities in association with a plurality of possible operating states of the display apparatus. The operating state here is, for example, a power state (ON state or OFF state) or a communication state (communicating or not communicating) with another device.

Furthermore, the priority holding unit 11b may use any means which can record data, such as a dynamic random access memory (DRAM), a synchronous dynamic random access memory (SDRAM), a flash memory, or a ferroelectric memory.

The control command processing unit (notifying unit) 11c receives, through the communication unit 11a, the control command transmitted from the BD player 13, and transmits a control command to the BD player 13 through the communication unit 11a. In the first embodiment, the control command processing unit 11c receives a priority check command and a power-on request command from the BD player 13 and transmits a priority notify command and a power-state notify command to the BD player 13. Specific details of the process will be described later. It is to be noted that the communication unit 11a transmits and receives the above control commands using the LRP.

More specifically, in response to the priority check command from the BD player 13, the priority notify command accompanied by, as a parameter, the information on the priority, is transmitted to the reproduction apparatus (that is the BD player 13 in this case) which is the source of the priority check command. Furthermore, when the display apparatus receives the power-on request command from the BD player 13, then the display apparatus is powered ON.

Meanwhile, the BD player 13 that is the reproduction apparatus transmits visual data or audio and visual data to the TV 11 and the projector 12 that are the display apparatuses, and is also capable of transmitting control commands to and receiving control commands from the TV 11 and the projector 12 via wireless communication networks. Furthermore, the BD player 13 transmits the priority check command and the power-on request command to each of the TV 11 and the projector 12, and is also capable of receiving the priority notify command and the power-state notify command from each of the TV 11 and the projector 12. Moreover, the BD player 13 is capable of determining and selecting the display apparatus (that is either the TV 11 or the projector 12 in this case) with the highest priority based on the priority notify commands received from the TV 11 and the projector 12.

Specifically, the BD player 13 includes a communication unit 13a, a control command processing unit 13b, and a content transmitting unit 13c. A structure of the communication unit 13a is the same as that of the communication unit 11a and therefore not described again.

The control command processing unit (selecting unit) 13b executes a process of selecting the display apparatus which transmits the content. Specifically, the control command processing unit 13b transmits and receives control commands to and from the display apparatuses (that are the TV 11 and the projector 12) to select one of the display apparatuses to which the content is to be transmitted, and executes a process of establishing an HRP connection to the selected display apparatus. Specific details of the process will be described later.

The content transmitting unit 13c receives the content, reproduces the received content, and transmits audio and visual data resulting from the reproduction, to the selected display apparatus through the communication unit 13a. The source of the content is not particularly limited, and the content may be obtained from a Blu-ray disc (BD) inserted to the BD player 13 or may be obtained from broadcast waves and the like, for example. The reproduction of the content indicates, for example, converting content to data (audio and visual data) in a format which can be displayed by the display apparatuses, such as decoding coded content.

In the AV network system configured as above, the control command processing unit 13b of the BD player 13 sequentially transmits the priority check commands to all the display apparatuses (that are the TV 11 and the projector 12 in this case) through the communication unit 13a with predetermined timings and receives the priority notify commands from all the display apparatuses through the communication unit 13a. The predetermined timings include, for example, a timing of when the BD player 13 is powered on, a timing of when a user is allowed to select the content reproduced by the BD player 13 (such as a timing of when a menu image is displayed), and a timing of when the BD player 13 starts reproducing the content.

Next, on the basis of the received priority notify command, the control command processing unit 13b determines and selects the display apparatus (that is either the TV 11 or the projector 12 in this case) with a high priority. The control command processing unit 13b then transmits the power-on request command to the selected display apparatus and executes the process of establishing an HRP connection to the display apparatus, thereby implementing the one-touch play.

The following describes the one-touch play operation based on specific priorities assigned to the TV 11 and the projector 12.

In FIG. 2, the TV 11 and the projector 12 hold, in the respective priority holding units 11b and 12b, values (priority information) indicating priorities of the one-touch play. The values indicating priorities are smaller for higher priorities.

As shown in FIG. 2, the priority held by the TV 11 is “2” regardless of whether the power state is ON or OFF. Also assume that the priority held by the projector 12 is “1” in power-on state and “3” in power-off state.

Setting of these priorities is made assuming that the power-on state of the projector 12 indicates that a user intends to view content on the projector 12, and the power-off state of the projector 12 indicates that a user intends to view content on the TV 11. That is, it is desirable that a priority be associated with a power state so that, as in the case of the projector 12, the priority associated with the ON state is higher than the priority associated with the OFF state.

The power-on state here indicates a state in which the display apparatus (such as the TV 11 and the projector 12) is supplied with power necessary to fulfill functions of a display apparatus such as a display function (that is, a state in which a main power is ON). On the other hand, the power-off state indicates a state of being not capable of the main functions of a display apparatus such as the display function, but being supplied with power enough to at least transmit and receive control commands (such as the priority check command and the priority notify command) to and from the reproduction as apparatus (such as the BD player).

Next, with reference to FIG. 3, the one-touch play operation with the projector 12 initially in power-on state is described.

In FIG. 3, for example, with a timing of content reproduction by the BD player 13, the control command processing unit 13b of the BD player 13 first transmits the priority check command to the projector 12.

In response to the priority check command from the BD player 13, the control command processing unit 12c of the projector 12 transmits the priority notify command to the BD player 13. At this time, the power state of the projector 12 is ON and therefore, the parameter to be added to the priority notify command is “1” that indicates the priority in ON state.

Subsequently, the control command processing unit 13b of the BD player 13 transmits the priority check command to the TV 11.

In response to the priority check command from the BD player 13, the control command processing unit 11c of the TV 11 transmits the priority notify command to the BD player 13. At this time, the priority of the TV 11 is “2” regardless of whether the power state is ON or OFF and therefore, the parameter to be added to the priority notify command is “2”.

The control command processing unit 13b of the BD player 13 compares the parameters (priorities) added to the respective priority notify commands received from the TV 11 and the projector 12, and determines, as the display apparatus for which the one-touch play is performed, the projector 12 that is the display apparatus with a higher priority.

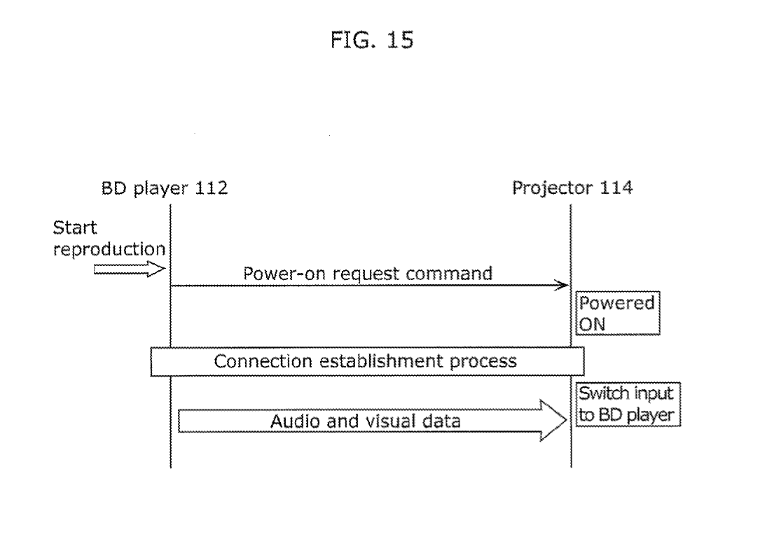

The one-touch play operation for the projector 12 by the BD player 13 is the same or alike as that in the conventional example described with reference to FIG. 15, and therefore is not described here.

Thus, with the projector 12 kept in power-on state, a user is always automatically allowed to view on the projector 12 the content reproduced by the BD player 13.

Next, with reference to FIG. 4, the one-touch play operation with the projector 12 initially in power-off state is described.

In FIG. 4, for example, with a timing of content reproduction by the BD player 13, the control command processing unit 13b of the BD player 13 first transmits the priority check command to the projector 12.

In response to the priority check command from the BD player 13, the control command processing unit 12c of the projector 12 transmits the priority notify command to the BD player 13. At this time, the power state of the projector 12 is OFF and therefore, the parameter to be added to the priority notify command is “3” that indicates the priority in OFF state.

Subsequently, the control command processing unit 13b of the BD player 13 transmits the priority check command to the TV 11.

In response to the priority check command from the BD player 13, the control command processing unit 11c of the TV 11 transmits the priority notify command to the BD player 13. At this time, the priority of the TV 11 is “2” regardless of whether the power state is ON or OFF and therefore, the parameter to be added to the priority notify command is “2”.

The control command processing unit 13b of the BD player 13 compares the parameters (priorities) added to the respective priority notify commands received from the TV 11 and the projector 12, and determines, as the display apparatus for which the one-touch play is performed, the TV 11 that is the display apparatus with a higher priority.

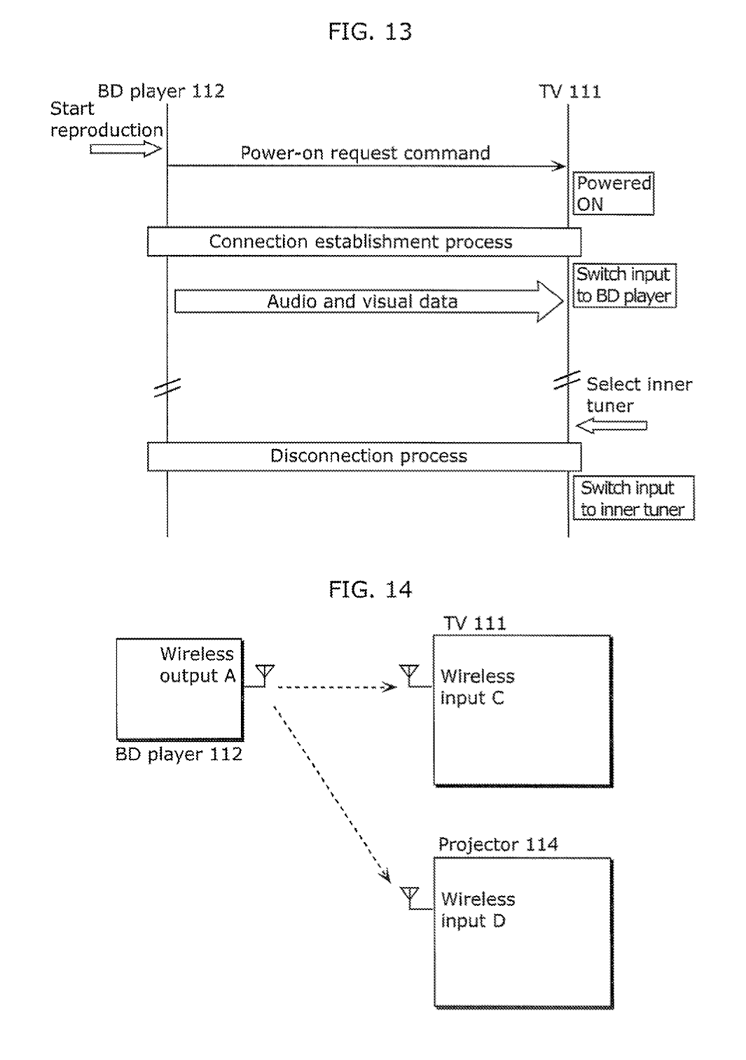

The one-touch play operation for the TV 11 by the BD player 13 is the same or alike as that in the conventional example described with reference to FIG. 13, and therefore is not described here.

Thus, with the projector 13 kept in power-off state, a user is always automatically allowed to view on the TV 11 the content reproduced by the BD player 13.

As above, upon a start of content reproduction by the BD player 13, the one-touch play can always be performed for the display apparatus on which the user wishes to view the content.

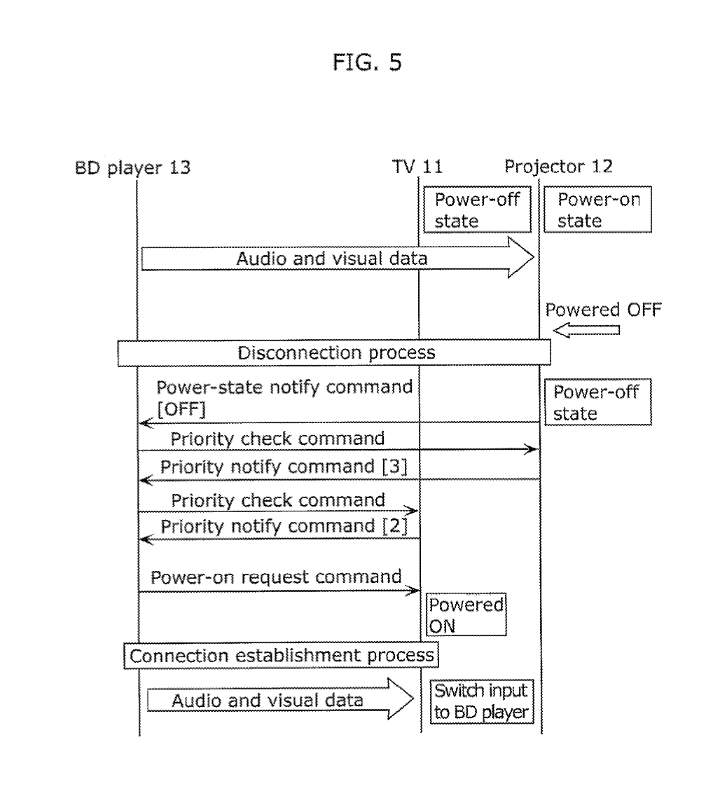

With reference to FIG. 5, the following describes an operation performed in the case where the projector 12 is powered off while content is being viewed on the projector 12 in the AV network system according to the first embodiment of the present invention. FIG. 5 shows an operation sequence in the case where the projector 12 included in the AV network system according to the first embodiment of the present invention is powered off while content is being viewed on the projector 12.

In FIG. 5, assume that the HRP connection has already been established between the BD player 13 and the projector 12, and the BD player 13 has been transmitting audio and visual data to the projector 12, and a user is viewing, on the projector 12, the audio and visual data (content) which is transmitted from the BD player 13.

In such a state, the projector 12 is powered off, and the control command processing unit 12c of the projector 12 then first severs the HRP connection between the projector 12 and the BD player 13. Subsequently, the control command processing unit 12c of the projector 12 transmits, to the BD player 13, a power-state notify command “OFF” indicating power off.

The control command processing unit 13b of the BD player 13 receives the power-state notify command which indicates that the projector 12 has been powered off, and then performs such a one-touch play operation as described above. At this time, the power state of the projector 12 is OFF and therefore, the one-touch play operation in this case is performed in the same operation sequence as that in FIG. 4.

As a result, the TV 11 which is in OFF state is powered on, and the audio and visual data of the content reproduced by the BD player 13 is output to the content display unit 11d of the TV 11.

That is, with a timing of when a change in the operating state of the selected display apparatus is detected, the control command processing unit 13b of the BD player 13 obtains the priorities again associated with current operating states of the plurality of apparatuses and re-selects one of the display apparatuses which holds the highest priority.

The operation as above allows the TV 11 to be automatically powered on when the projector 12 is powered off, resulting in automatic switching from the projector 12 to the TV 11 so that the content reproduced by the BD player 13 can be viewed on the TV 11.

At this time, the control command processing unit 13b of the BD player 13 may transmit the priority check commands to all the connected display apparatuses (that are the TV 11 and the projector 12) to re-obtain the priorities as shown in FIG. 5. The process in initial selecting (FIGS. 2 and 3) and the process in re-selecting (FIG. 5) can be the same.

However, it can be considered that a power-off of the projector 12 by a user who is viewing the content on the projector 12 indicates that the user wishes to stop viewing the content on the projector 12 and view the content on the TV 11.

Thus, instead of the process in FIG. 5, the priority check command may be transmitted to the other display apparatus than the projector 12 that had been selected until immediately before the re-selecting operation. Comparison may be then made among the parameters (priorities) added to the priority notify commands received in response to the above priority check commands, to select the display apparatus which holds the highest priority. Alternatively, it is also possible that the priority check commands are transmitted to all the display apparatuses and in the process of comparing their priorities, the display apparatus which had been selected until immediately before the re-selecting operation is excluded.

Although the embodiment shown in FIG. 5 gives an example in which the projector 12 transmits, to the BD player 13, the power-state notify command indicating power off, the present invention is not limited to this example, and it is possible that, for example, the projector 12 transmits, to the BD player 13, a control command which causes the BD player 13 to perform the one-touch play operation again, but is different from the power-state notify command.

Furthermore, in the AV network system according to the first embodiment of the present invention, the setting of topology and priorities of the TV 11, the projector 12, and the BD player 13 is an example and not limited to this example.

Furthermore, the setting of priorities of the respective display apparatuses shown in FIG. 2 is merely an example as already described. Specifically, the setting is made assuming that a user uses the projector 12 when the projector 12 is in power-on state, and a user uses the TV 11 when the projector 12 is in power-off state. This means that a different setting of priorities is possible in the case assuming a different use situation. For example, the setting of priority of the projector 12 may be always “1” regardless of its power state in the case where a user wishes to view content on the projector 12 regardless of whether the power state of the projector 12 is ON or OFF when the projector 12 is present in a wireless communication network.

Furthermore, although the priority is set in association with the power-on state or the power-off state in the first embodiment of the present invention, it is also possible that the priority is set in association with other conditions than the power state. Specifically, the priority may be set in association with whether or not the display apparatus performs communication with a reproduction apparatus different from the BD player 13 (i.e. whether or not there is an established HRP connection between the display apparatus and a reproduction apparatus different from the BD player 13). In this case, the priority of the display apparatus which does not perform communication with other reproduction apparatuses is desirably set to be higher than the priority of the display apparatus which performs communication with other reproduction apparatuses.

Furthermore, although the BD player 13 first transmits the priority check command to the projector 12 in the first embodiment of the present invention, the order of transmitting the priority check command is not limited to this, and the priority check command may be transmitted first to the TV 11.

Furthermore, the first embodiment of the present invention has been described about the case, as an example, where the reproduction apparatus, i.e. the BD player 13, is capable of receiving, from all the display apparatuses, i.e. the TV 11 and the projector 12, the priority notify commands in response to the priority check commands, but the present invention is not limited to this case. For example, the configuration may be such that when the BD player 13 transmits the priority check command to one display apparatus (which is assumed here to be the TV 11) and receives no priority notify command from the TV 11 within a predetermined time period, then the next operation will be performed with the TV 11 ignored. In this case, the BD player 13 determines and selects the display apparatus with the highest priority, based on the priority notify commands received from the other display apparatuses than the TV 11.

Furthermore, in the first embodiment of the present invention, the BD player 13 transmits the power-on request command to the display apparatus (that is either the TV 11 or the projector 12) for which the one-touch play is determined to be performed, regardless of whether the power state of the display apparatus is ON or OFF. Alternatively, it is also possible that before the transmission of the power-on request command, the power state of the display apparatus is checked so that the power-on request command will be transmitted only when the power state of the display apparatus is OFF.

Specifically, it is possible that the control command processing unit 13b of the BD player 13 transmits a power-state check command for checking a current power state to the selected display apparatus, and only when the power-state notify command received in response to the power-state check command has a value indicating that the current power-state of the display apparatus is OFF, the control command processing unit 13b of the BD player 13 transmits the power-on request command.

It is also possible that after transmitting the power-on request command to the display apparatus (that is either the TV 11 or the projector 12) for which the one-touch play is determined to be performed, the BD player 13 checks the power state of the display apparatus and stands by without starting reproduction until the display apparatus is powered on. In this case, it is sufficient that the power state of the display apparatus is checked every few seconds, for example.

Specifically, it is possible that the control command processing unit 13b of the BD player transmits, to the selected display apparatus, the power-state check command for checking the current power state of the display apparatus, and after checking that the power-state notify command received in response to the power-state check command has a value indicating that the current power state of the display apparatus is ON, the control command processing unit 13b of the BD player starts the process of establishing a connection.

Furthermore, although the BD player 13 outputs the audio and visual data to the display apparatus for which the one-touch play is determined to be performed in the first embodiment of the present invention, the BD player 13 may output the visual data only.

Furthermore, the description in the first embodiment of the present invention gives, as an example of the predetermined timing, a timing of when the BD player 13 starts reproducing content, but the predetermined timing is not limited to this timing, and for example, the one-touch play operation may be performed with a timing of power on of the BD player 13 or with a timing of displaying a menu on which a user selects content to be reproduced.

Furthermore, the first embodiment of the present invention has been described about the case, as an example, where one BD player 13 is provided as the reproduction apparatus, but the present invention is not limited to this case, and for example, the reproduction apparatus may be a BD recorder or an STB, and not one reproduction apparatus but a plurality of reproduction apparatuses may be present.

Furthermore, the first embodiment of the present invention has been described about the case, as an example, where the two display apparatuses, i.e. the TV 11 and the projector 12, are present, but the present invention is not limited to this case, and the display apparatuses may be of other types, a plurality of display apparatuses of the same type may be present, and three or more display apparatuses may be present.

Furthermore, the first embodiment of the present invention has been described about the case, as an example, where the BD player 13 transmits visual data to and transmits and receives control commands to and from each of the TV 11 and the projector 12 via a wireless communication network, that is, the case where the communication units 11a, 12a, and 13a are wireless communication interfaces, but the present invention is not limited to this case, and other communication networks (wireless communication networks of other types, wired communication networks, or the like) may be used, which means that the other interfaces may be used.

### Second Embodiment

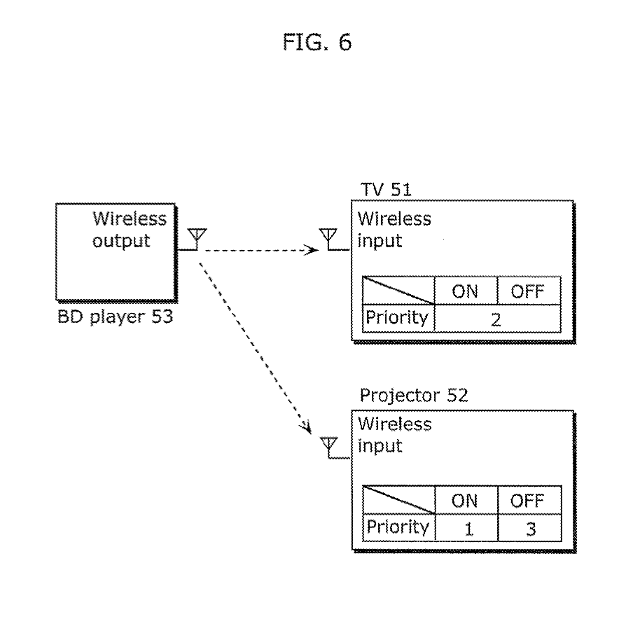

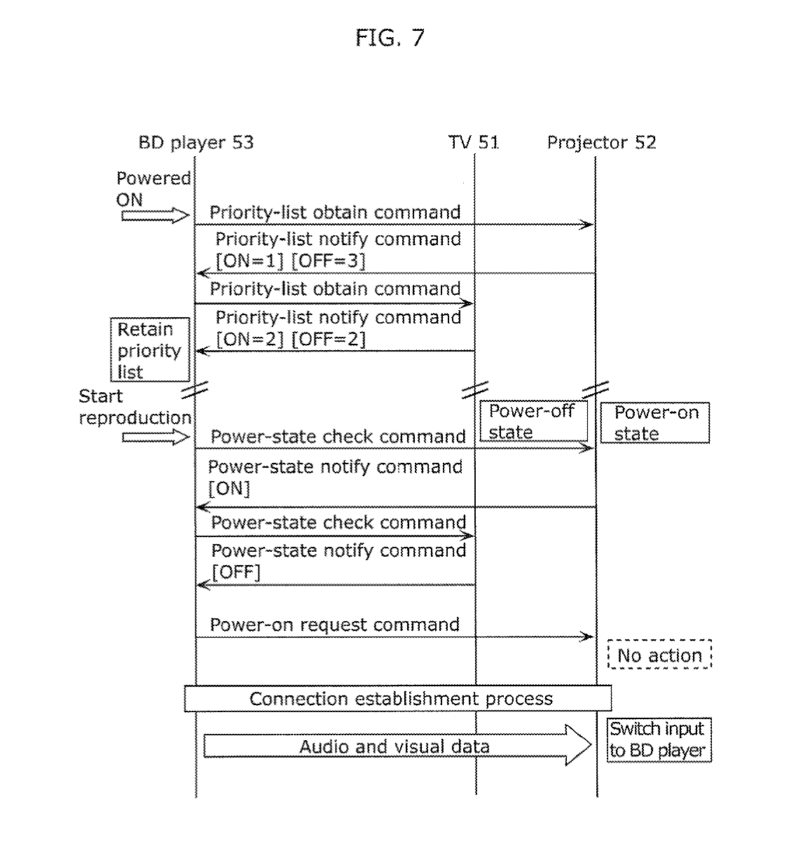

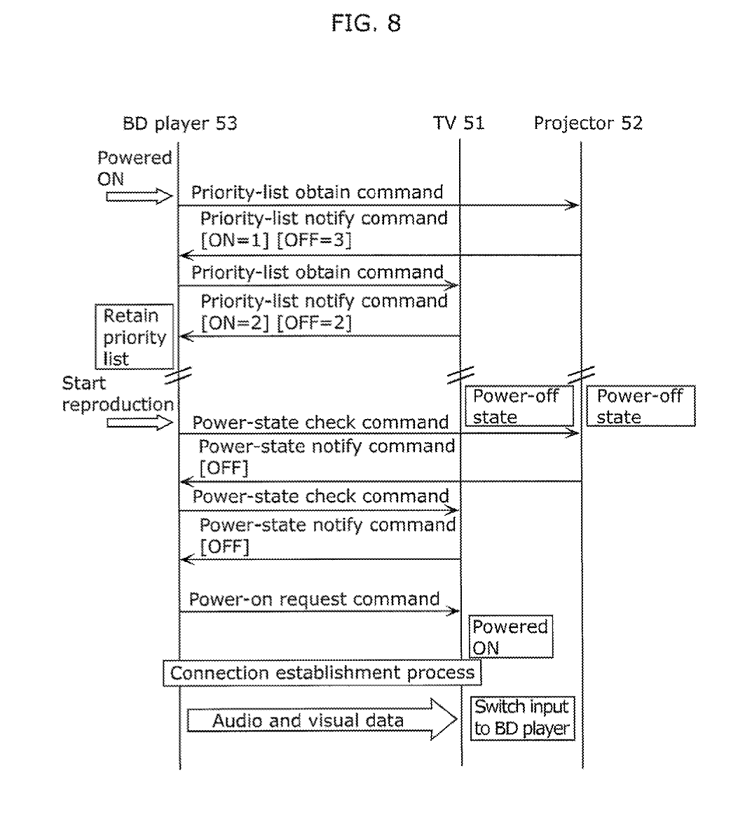

With reference to FIGS. 6 to 8, a structure of an AV network system and a one-touch play operation according to the second embodiment of the present invention are described. FIG. 6 shows an example of a structure of the AV network system including display apparatuses and a reproduction apparatus according to the second embodiment of the present invention. FIG. 7 shows a sequence of a one-touch play operation started from a BD player which is the reproduction apparatus according to the second embodiment of the present invention, when a projector which is one of the display apparatuses according to the second embodiment of the present invention is in power-on state. FIG. 8 shows a sequence of a one-touch play operation started from the BD player which is the reproduction apparatus according to the second embodiment of the present invention, when the projector which is one of the display apparatuses according to the second embodiment of the present invention is in power-off state.

In FIG. 6, the AV network system includes a BD player 53 that is the reproduction apparatus, and a TV 51 and a projector 52 that are the display apparatuses each connected to the BD player 53 via a wireless communication network.

The TV 51 and the projector 52 that are the display apparatuses respectively include the communication units 11a and 12a, the priority holding units 11b and 12b, the control command processing units 11c and 12c, and the content display units 11d and 12d, which are the same or alike as those included in the TV 11 and the projector 12 according to the first embodiment of the present invention. The BD player 53 that is the reproduction apparatus includes the communication unit 13a, the control command processing unit 13b, and the content transmitting unit 13c, which are the same or alike as those included in the BD player 13 according to the first embodiment of the present invention. Focusing on differences from the first embodiment, a processing operation of the one-touch play according to the second embodiment of the present invention is described below.

The TV 51 and the projector 52 that are the display apparatuses receive visual data or audio and visual data from the BD player 53 that is the reproduction apparatus, and are also capable of transmitting control commands to and receiving control commands from the BD player 53, via wireless communication networks. In addition, with an established connection to the BD player 53, the TV 51 and the projector 52 are capable of displaying the received visual data or audio and visual data. Furthermore, among information on display priorities (hereinafter referred to as priorities) assigned to all the display apparatuses connected to the BD player 53 via wireless communication networks, information on the priority of the TV 51 or the projector 52 is held in form of a priority list by the TV 51 or the projector 52 itself, which priority list combines a power state indicating whether the TV 51 or the projector 52 itself is in power-on state or power-off state with the priority associated with the power state of the TV 51 or the projector 52 itself.

When the TV 51 and the projector 52 receive priority-list obtain commands from the BD player 53, the TV 51 and the projector 52 transmit priority-list notify commands each of which is accompanied by, as a parameter, information on the priority list, to the reproduction apparatus (that is the BD player 53 in this case) which is the source of the priority-list obtain commands, and when the TV 51 and the projector 52 receive power-state check commands from the BD player 53, the TV 51 and the projector 52 transmit power-state notify commands each of which is accompanied by a current power state as a parameter, to the reproduction apparatus (that is the BD player 53 in this case) which is the source of the power-state check commands. Furthermore, when the display apparatus receives the power-on request command from the BD player 53, then the display apparatus is powered on.

In short, the control command processing units 11c and 12c according to the second embodiment are different from those according to the first embodiment in notifying the BD player 53 of all the priorities held in the priority holding units 11b and 12b, in the form of the priority list.

Meanwhile, the BD player 53 that is the reproduction apparatus transmits visual data or audio and visual data to the TV 51 and the projector 52 that are the display apparatuses, and is also capable of transmitting control commands to and receiving control commands from the TV 51 and the projector 52, via wireless communication networks. Furthermore, the BD player 53 transmits the priority-list obtain command, the power-state check command, and the power-on request command to each of the TV 51 and the projector 52, receives the priority-list notify command and the power-state notify command from each of the TV 51 and the projector 52, and is also capable of retaining the priority lists.

The BD player 53 then determines and selects the display apparatus (that is either the TV 51 or the projector 52 in this case) with the highest priority based on the priority-list notify commands and the power-state notify commands received from the TV 51 and the projector 52.

Specifically, the control command processing unit 13b according to the second embodiment extracts the priorities associated with the received power states from the priority lists obtained from the TV 51 and the projector 52. The control command processing unit 13b then compares the extracted priorities and selects the display apparatus which holds the highest priority, which is different from the first embodiment.

In the AV network system configured as above, the control command processing unit 13b of the BD player 53 sequentially transmits, with predetermined timings, the priority-list obtain commands and the In power-state check commands to all the display apparatuses (that are the TV 51 and the projector 52 in this case) through the communication unit 13a and receives the priority-list notify commands and the power-state notify commands from all the display apparatuses through the communication unit 13a. The control command processing unit 13b then determines and selects the display apparatus (that is either the TV 51 or the projector 52 in this case) with the highest priority based on the received priority-list notify commands and power-state notify commands. Furthermore, the control command processing unit 13b then transmits the power-on request command to the selected display apparatus and executes the process of establishing an HRP connection to the display apparatus, thereby implementing the one-touch play.

The following describes the one-touch play operation based on specific priorities assigned to the TV 51 and the projector 52.

The TV 51 and the projector 52 hold, in the priority holding units 11b and 12b, respectively, values indicating priorities of the one-touch play in association with the power-on state and the power-off state. The values indicating priorities are smaller for higher priorities.

As shown in FIG. 6, the priority held by the TV 51 is “2” regardless of whether the power state is ON or OFF. The priority held by the projector 52 is “1” in power-on state and “3” in power-off state. It is to be noted that as mentioned above, the information including all the combinations of the operating states (the power states) with the priorities associated with the operating states is referred to as the priority list.

Setting of these priorities is made assuming that the power-on state of the projector 52 indicates that a user intends to view content on the projector 52, and the power-off state of the projector 52 indicates that a user intends to view content on the TV 51.

Next, with reference to FIG. 7, the one-touch play operation started from the BD player 53 with the projector 52 in power-on state is described.

First, described is an operation performed, for example, when the control command processing unit 13b of the BD player 53 obtains the priority list of each of the display apparatuses with a timing of power on of the BD player 53.

In FIG. 7, the control command processing unit 13b of the BD player 53 transmits, upon power on thereof, the priority-list obtain command to the projector 52.

In response to the priority-list obtain command from the BD player 53, the control command processing unit 12c of the projector 52 transmits, to the BD player 53, the priority-list notify command accompanied by the priority list.

Subsequently, the control command processing unit 13b of the BD player 53 transmits the priority-list obtain command to the TV 51. In response to the priority-list obtain command from the BD player 53, the control command processing unit 11c of the TV 51 transmits, to the BD player 53, the priority-list notify command accompanied by the priority list.

The control command processing unit 13b of the BD player 53 receives the respective priority lists transmitted from the projector 52 and the TV 51 in response to the priority-list obtain commands, and stores the received priority lists into a memory (not shown).

Subsequently, described is the one-touch play operation performed when the BD player 53 starts reproducing content with the projector 52 initially in power-on state.

Upon a start of content reproduction by the BD player 53, the control command processing unit 13b of the BD player 53 first transmits the power-state check command to the projector 52.

In response to the power-state check command from the BD player 53, the control command processing unit 12c of the projector 52 transmits, to the BD player 53, the power-state notify command indicating power on.

Subsequently, the control command processing unit 13b of the BD player 53 transmits the power-state check command to the TV 51. In response to the power-state check command from the BD player 53, the control command processing unit 11c of the TV 51 transmits, to the BD player, the power-state notify command indicating power off.

The control command processing unit 13b of the BD player 53 refers to the priority lists of the TV 51 and the projector 52 which have been stored in a memory (not shown), to compare the priorities associated with the current power states of the TV 51 and the projector 52, and thereby determines, as the display apparatus for which the one-touch play is performed, the projector 52 that is the display apparatus with the highest priority.

The one-touch play operation for the projector 52 by the BD player 53 is the same or alike as that in the conventional example described with reference to FIG. 15, and therefore is not described here.

Thus, with the projector 52 kept in power-on state, a user is always automatically allowed to view on the projector 52 the content reproduced by the BD player 53.

Next, with reference to FIG. 8, the one-touch play operation started from the BD player 53 with the projector 52 in power-off state is described.

The operation in FIG. 8 from power on of the BD player 53 to reception and storage of the priority lists of the projector 52 and the TV 51 is the same as that in the power-on state of the projector 52 described with reference to FIG. 7 and therefore is not described here, and the following description begins from a start of content reproduction by the BD player 53.

Upon a start of content reproduction by the BD player 53, the control command processing unit 13b of the BD player 53 first transmits a power-state check command to the projector 52 as in the operation shown in FIG. 7.

In response to the power-state check command from the BD player 53, the control command processing unit 12c of the projector 52 transmits, to the BD player 53, the power-state notify command indicating power off.

Subsequently, the control command processing unit 13b of the BD player 53 transmits the power-state check command to the TV 51. In response to the power-state check command from the BD player 53, the control command processing unit 11c of the TV 51 transmits, to the BD player 53, the power-state notify command indicating power off.

The control command processing unit 13b of the BD player 53 refers to the priority lists of the TV 51 and the projector 52 which have been stored in a memory (not shown), to compare the priorities associated with the current power states of the TV 51 and the projector 52, and thereby determines, as the display apparatus for which the one-touch play is performed, the TV 51 that is the display apparatus with the highest priority.

The one-touch play operation for the TV 51 by the BD player 53 is the same or alike as that in the conventional example described with reference to FIG. 13, and therefore is not described here.

Thus, with the projector 52 kept in power-off state, a user is always automatically allowed to view on the TV 51 the content reproduced by the BD player 53.

The operation as above allows automatic implementation of the one-touch play for the display apparatus on which a user wishes to view content, upon a start of every content reproduction by the BD player 53.

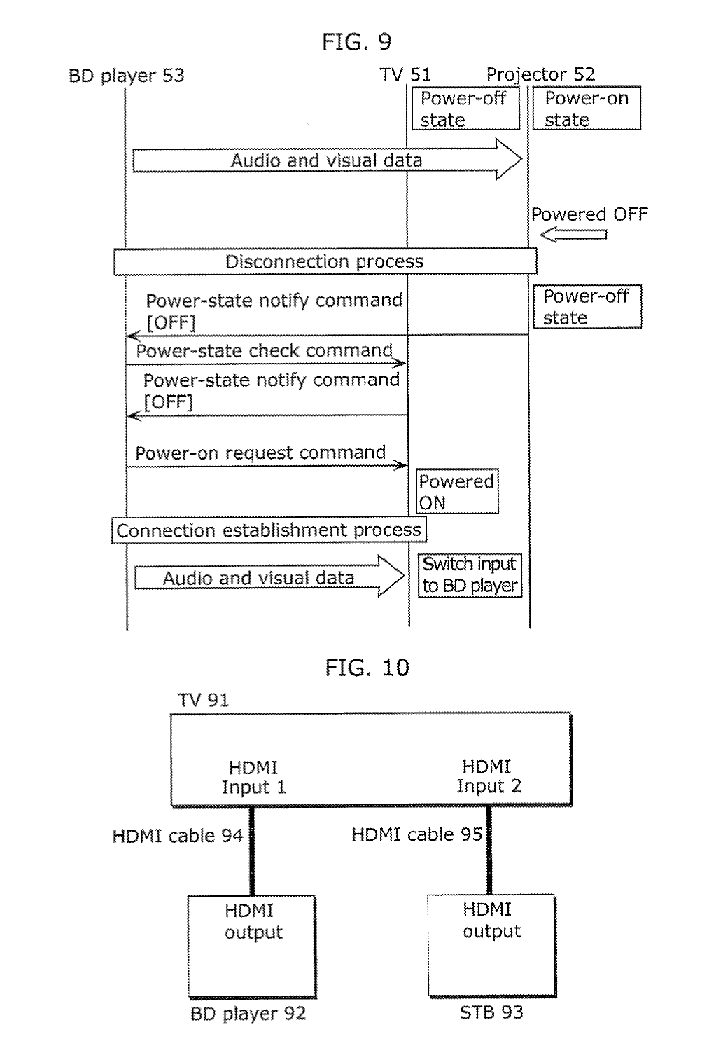

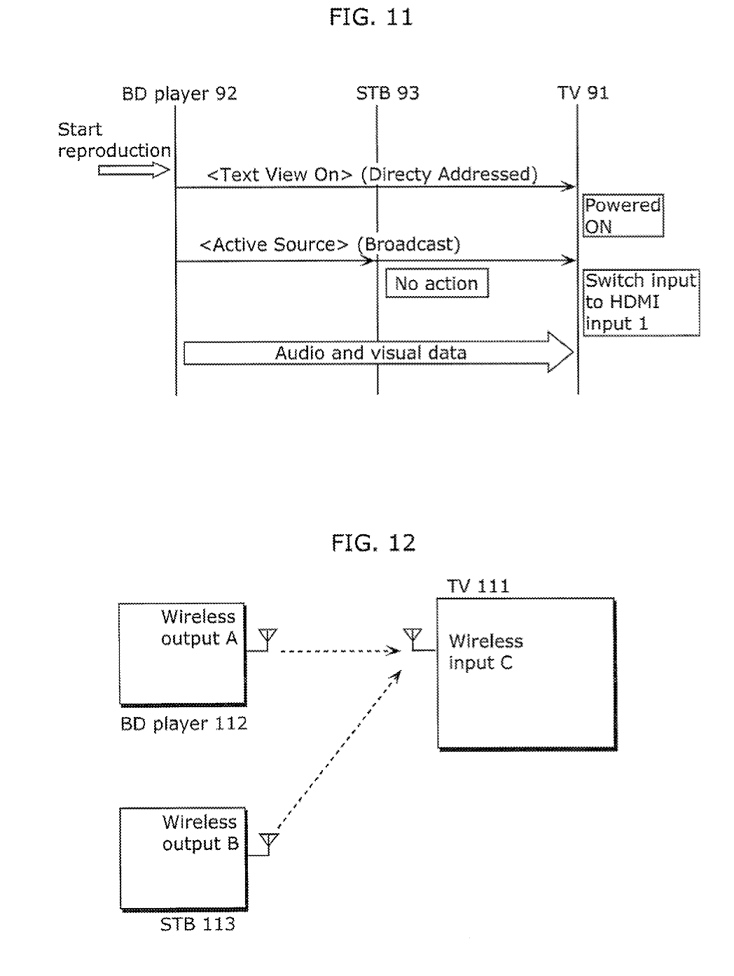

With reference to FIG. 9, the following describes an operation performed in the case where the projector is powered off while content is being viewed on the projector in the AV network system according to the second embodiment of the present invention. FIG. 9 shows an operation sequence in the case where the projector included in the AV network system according to the second embodiment of the present invention is powered off while content is being viewed on the projector.

In FIG. 9, assume that the HRP connection has already been established between the BD player 53 and the projector 52, and the BD player 53 has been transmitting audio and visual data to the projector 52, and a user is viewing, on the content display unit 12d of the projector 52, the audio and visual data (content) which is transmitted from the BD player 53.

In such a state, the projector 52 is powered off, and the control command processing unit 12c of the projector 52 then first severs the HRP connection between the projector 52 and the BD player 53. Subsequently, the control command processing unit 12c transmits, to the BD player 53, a power-state notify command “OFF” indicating power off.

The control command processing unit 13b of the BD player 53 receives the power-state notify command which indicates that the projector 52 has been powered off, and then performs such a one-touch play operation as described above. At this time, the power state of the projector 52 is OFF and therefore, the one-touch play operation in this case is performed in the same operation sequence as that in FIG. 8.

At this time, since the control command processing unit 13b of the BD player 53 knows that the power state of the projector 52 is OFF, the power-state notify command is not required to be transmitted (of course, may be transmitted) to the projector 52.

As a result, when the power state of the TV 51 is OFF, the TV 51 is powered on in response to the power-on request command from the BD player 53, so that audio and visual data of the content reproduced by the BD player 53 is output to a display unit (not shown) of the TV 51.

The operation as above allows the TV 51 to be automatically powered on when the projector 52 is powered off, resulting in automatic switching from the projector 52 to the TV 51 so that the content reproduced by the BD player 53 can be viewed on the TV 51.

Although the embodiment shown in FIG. 9 gives an example in which the projector 52 transmits, to the BD player 53, the power-state notify command indicating power off, the present invention is not limited to this example, and it is possible that, for example, the projector 52 transmits, to the BD player 53, a control command which causes the BD player 53 to perform the one-touch play operation again, but is different from the power-state notify command.

Furthermore, in the AV network system according to the second embodiment of the present invention, the setting of topology and priorities of the TV 51, the projector 52, and the BD player 53 is an example and not limited to this example.

Furthermore, the setting of priorities of the respective display apparatuses shown in FIG. 6 is merely an example as already described. Specifically, the setting is made assuming that a user uses the projector 52 when the projector 52 is in power-on state, and a user uses the TV 51 when the projector 52 is in power-off state. This means that a different setting of priorities is possible in the case assuming a different use situation. For example, the setting of priority of the projector 52 may be always “1” regardless of its power state in the case where a user wishes to view content on the projector 52 regardless of whether the power state of the projector 52 is ON or OFF when the projector 52 is present in a radio communication network.

Furthermore, although the priority is set in association with the power-on state or the power-off state in the second embodiment of the present invention, it is also possible that the priority is set in association with other conditions than the power state. In this case, however, upon a start of content reproduction, the BD player 53 needs to obtain not only information on the power state of each of the display apparatuses, but also information required to specify the priority of each of the display apparatuses.

Furthermore, although the BD player 53 first transmits the priority-list obtain command and the power-state check command to the projector 52 in the second embodiment of the present invention, the order of transmitting the priority-list obtain command and the power-state check command is not limited to this, and these commands may be transmitted first to the TV 51.

Furthermore, the second embodiment of the present invention has been described about the case, as an example, where the reproduction apparatus, i.e. the BD player 53, is capable of receiving the priority-list notify commands and the power-state notify commands transmitted from all the display apparatuses, i.e. the TV 51 and the projector 52, in response to the priority-list obtain commands and the power-state check commands, respectively, but the present invention is not limited to such a case. For example, the configuration may be such that when the BD player 53 transmits the priority-list obtain command or the power-state check command to one display apparatus (which is assumed here to be the TV 51) and receives no priority-list notify command or no power-state notify command from the TV 51 within a predetermined time period, then the next operation will be performed with the TV 51 ignored. In this case, the BD player 53 determines and selects the display apparatus with the highest priority, based on the priority-list notify commands and the power-state notify commands received from the other display apparatuses than the TV 51.

Furthermore, although the BD player 53 transmits the power-on request command to the display apparatus (that is either the TV 51 or the projector 52) for which the one-touch play is determined to be performed, regardless of whether the power state of the display apparatus is ON or OFF in the second embodiment of the present invention, it is also possible that before the transmission of the power-on request command, the power state of the display apparatus is checked so that the power-on request command will be transmitted only when the power state of the display apparatus is OFF.

It is also possible that after transmitting the power-on request command to the display apparatus (that is either the TV 51 or the projector 52) for which the one-touch play is determined to be performed, the BD player 53 checks the power state of the display apparatus and stands by without starting content reproduction until the display apparatus is powered on. In this case, it is sufficient that the power state of the display apparatus is checked every few seconds, for example.

Furthermore, although the BD player 53 outputs the audio and visual data to the display apparatus for which the one-touch play is determined to be performed in the second embodiment of the present invention, it is also possible that the BD player 53 outputs the visual data only.

Furthermore, the description in the second embodiment of the present invention gives, as an example of the predetermined timing, a timing of when the BD player 53 is powered on, but the predetermined timing is not limited to this timing, and for example, the one-touch play operation may be performed with a timing of a start of content reproduction by the BD player 53 or with a timing of displaying a menu on which a user selects content to be reproduced.

Furthermore, although the second embodiment of the present invention has been described about the case, as an example, where one BD player 53 is provided as the reproduction apparatus, the present invention is not limited to this case, and for example, the reproduction apparatus may be a BD recorder or an STB, and not one reproduction apparatus but a plurality of reproduction apparatuses may be present.

Furthermore, the second embodiment of the present invention has been described about the case, as an example, where the two display apparatuses, i.e. the TV 51 and the projector 52, are present, but the present invention is not limited to this case, and the display apparatus may be of other types, a plurality of display apparatuses of the same type may be present, and three or more display apparatuses may be present.

Furthermore, the second embodiment of the present invention has been described about the case, as an example, where the BD player 53 transmits visual data to and transmits and receives control commands to and from each of the TV 51 and the projector 52 via a radio communication network, that is, the case where the communication units 11a, 12a, and 13a are wireless communication interfaces, but the present invention is not limited to this case, and other communication networks (radio communication networks of other types, wired communication networks, or the like) may be used, which means that the other interfaces may be used.

### (Other Variations)

Although the present invention has been described so far based on the above embodiments, the present invention is, of course, not limited to the above embodiments. The following cases are also included in the present invention.

The above apparatuses specifically constitute a computer system which includes a microprocessor, a ROM, a RAM, a hard disk unit, a display unit, a keyboard, and a mouse. The RAM or the hard disk unit stores a computer program. The microprocessor operates according to the computer program, thereby allowing the apparatuses to fulfill functions thereof. Here, the computer program is constructed by combining a plurality of operation codes indicating instructions to a computer, in order to fulfill predetermined functions.

Part or all of the constituents included in the above apparatuses may be provided in one system LSI (large scale integration). The system LSI is a super multifunctional LSI manufactured by integrating plural constituents into one chip and is specifically a computer system which includes a microprocessor, a ROM, and a RAM. The RAM stores a computer program. The microprocessor operates according to the computer program, thereby allowing the system LSI to fulfill functions thereof.

Part or all of the constituents included in the above apparatuses may be provided in an IC card or a single module which can be inserted into and removed from the apparatuses. The IC card or the module is a computer system which includes a microprocessor, a ROM, and a RAM. The IC card or the module may include the above super multifunctional LSI. The microprocessor operates according to the computer program, thereby allowing the IC card or the module to fulfill functions thereof. This IC card or this module may have tamper resistance.

The present invention may be a method described above. Furthermore, the present invention may be a computer program which causes a computer to execute the method or may be a digital signal of the computer program.

Furthermore, the present invention may be a computer-readable recording medium on which the computer program or the digital signal is recorded and which includes, for example, a flexible disk, a hard disk, a CD-ROM, an MO, a DVD, a DVD-ROM, a DVD-RAM, a BD (Blu-ray Disc), and a semiconductor memory. The present invention may also be a digital signal recorded on the recording medium.

Furthermore, the present invention may be transmission of the computer program or the digital signal via a network represented by a telecommunication line, a wired or wireless communication line, and the Internet, or data broadcasting, etc.

Furthermore, the present invention may be a computer system including a memory which stores the above computer program and a microprocessor which operates according to the computer program.

Furthermore, the program or digital signal may be recorded on the recording medium and thus transmitted, or the program or the digital signal may be transmitted via the network or the like, so that the present invention can be implemented by another independent computer system.

The above embodiments and the above variations may be combined.

While the embodiments of the present invention have been described above with reference to the drawings, the present invention is not limited to the illustrated embodiments. Various modifications and variations may be made to the illustrated embodiments within the literal or equivalent scope of the claimed invention.

### INDUSTRIAL APPLICABILITY

The present invention is applicable to AV network systems, such as a home theater, including a reproduction apparatus and a plurality of display apparatuses each connected to the reproduction apparatus via a communication network.

### REFERENCE SIGNS LIST

11, 51, 91, 111 TV
11a, 12a, 13a Communication unit
11b, 12b Priority holding unit
11c, 12c, 13b Control command processing unit
11d, 12d Content display unit
12, 52, 114 Projector
13, 53, 92, 112 BD player
13c Content transmitting unit
93, 113 STB
94, 95 HDMI cable

An integrated circuit that transmits content to one of a plurality of display apparatuses each of which is connected via a communication network, said integrated circuit comprising:
a selecting unit configured to obtain a priority from each of said display apparatuses via the communication network and select one of the display apparatuses which holds a highest priority, the priority indicating a priority order of a corresponding one of said display apparatuses to display the content; and

a content transmitting unit configured to transmit the content to the display apparatus selected by said selecting unit.

1. A reproduction apparatus that transmits content to one of a plurality of display apparatuses each of which is connected to said reproduction apparatus via a communication network, said reproduction apparatus comprising:
a selecting unit configured to obtain a priority from each of the display apparatuses via the communication network and select one of the display apparatuses which holds a highest priority, the priority indicating a priority order of a corresponding one of the display apparatuses to display the content; and
a content transmitting unit configured to transmit the content to the display apparatus selected by said selecting unit.

2. The reproduction apparatus according to claim 1,
wherein each of the display apparatuses holds a plurality of priorities in association with a plurality of possible operating states of the display apparatus, and
said selecting unit is configured to obtain only one of the priorities which is associated with a current operating state of each of the display apparatuses.

3. The reproduction apparatus according to claim 2,
wherein with a timing of when a change in the operating state of the selected display apparatus is detected, said selecting unit is configured to obtain again the priority associated with the current operating state of each of the display apparatuses and newly select one of the display apparatuses which holds a highest priority.

4. The reproduction apparatus according to claim 3,
wherein said selecting unit is configured to newly select one of the display apparatuses which holds a highest priority and is different from the display apparatus selected until immediately before.

5. The reproduction apparatus according to claim 1,
wherein said selecting unit is further configured to transmit, to the selected display apparatus, a power-on request command for placing the display apparatus in power-on state, and execute a process of establishing a connection between said reproduction apparatus and the display apparatus, and
said content transmitting unit is configured to transmit the content through the established connection.

6. The reproduction apparatus according to claim 5,
wherein said selecting unit is further configured to transmit, to the selected display apparatus, a power-state check command for checking a current power state, and transmit the power-on request command to the selected display apparatus when a power-state notify command received in response to the power-state check command has a value indicating that the current power state of the display apparatus is OFF.

7. The reproduction apparatus according to claim 5,
wherein said selecting unit is further configured to (i) transmit, to the selected display apparatus, a power-state check command for checking a current power state, and after checking that a power-state notify command received in response to the power-state check command has a value indicating that the current power state of the display apparatus is ON, (ii) start the process of establishing the connection.

8. The reproduction apparatus according to claim 1,
wherein said selecting unit is configured to execute a process of selecting one of the display apparatuses which holds a highest priority, with one of the following timings: a timing of when said reproduction apparatus is powered on; a timing of when a user is allowed to select the content reproduced by said reproduction apparatus; and a timing of when reproduction of the content by said reproduction apparatus starts.

9. The reproduction apparatus according to claim 1,
wherein the communication network is of a wireless high definition (wirelessHD),
said selecting unit is configured to obtain the priority through a low-rate physical layer (LRP), and
said content transmitting unit is configured to transmit the content through a high-rate physical layer (HRP).

10. The reproduction apparatus according to claim 1,
wherein each of the display apparatuses holds a plurality of priorities in association with a plurality of possible operating states of the display apparatus, and
said selecting unit is configured to obtain, from each of the display apparatuses, the priorities held by the display apparatus, and a current operating state of the display apparatus, and select one of the display apparatuses of which priority associated with the current operating state is highest.

11. A display apparatus that is one of a plurality of display apparatuses connected to a reproduction apparatus via a communication network and displays content received from the reproduction apparatus, said display apparatus comprising:
a priority holding unit configured to hold a priority indicating a priority order of said display apparatus among the plurality of display apparatuses to display the content received from the reproduction apparatus;
a notifying unit configured to notify, via the communication network, the reproduction apparatus of the priority held by said priority holding unit, in response to a request from the reproduction apparatus; and
a display unit configured to display the content received from the reproduction apparatus.

12. The display apparatus according to claim 11,
wherein said priority holding unit is configured to hold a plurality of priorities associated with a plurality of power states of said display apparatus, and
a priority associated with an ON state is higher than a priority associated with an OFF state.

13. An AV network system comprising:
a reproduction apparatus; and
a plurality of display apparatuses each of which is connected to said reproduction apparatus via a communication network,
wherein said AV network system displays, on one of said display apparatuses, content transmitted from said reproduction apparatus via the communication network,
said reproduction apparatus includes:
a selecting unit configured to obtain a priority from each of said display apparatuses via the communication network and select one of the display apparatuses which holds a highest priority, the priority indicating a priority order of a corresponding one of said display apparatuses to display the content; and
a content displaying unit configured to transmit the content to said display apparatus selected by said selecting unit, and
each of said display apparatuses includes:
a priority holding unit configured to hold a priority indicating a priority order of said display apparatus among said plurality of display apparatuses to display the content received from said reproduction apparatus;
a notifying unit configured to notify, via the communication network, said reproduction apparatus of the priority held by said priority holding unit, in response to a request from said reproduction apparatus; and
a display unit configured to display the content received from said reproduction apparatus.

14. A reproduction method of transmitting content to one of a plurality of display apparatuses each of which is connected via a communication network, said reproduction method comprising:
obtaining a priority from each of the display apparatuses via the communication network and selecting one of the display apparatuses which holds a highest priority, the priority indicating a priority order of a corresponding one of the display apparatuses to display the content; and
transmitting the content to the display apparatus selected in said selecting.

15. A program causing a computer to transmit content to one of a plurality of display apparatuses each of which is connected via a communication network, said program causing the computer to execute:
obtaining a priority from each of the display apparatuses via the communication network and selecting one of the display apparatuses which holds a highest priority, the priority indicating a priority order of a corresponding one of the display apparatuses to display the content; and
transmitting the content to the display apparatus selected in said selecting.

16. An integrated circuit that transmits content to one of a plurality of display apparatuses each of which is connected via a communication network, said integrated circuit comprising:
a selecting unit configured to obtain a priority from each of said display apparatuses via the communication network and select one of the display apparatuses which holds a highest priority, the priority indicating a priority order of a corresponding one of said display apparatuses to display the content; and
a content transmitting unit configured to transmit the content to the display apparatus selected by said selecting unit.
